(19) United States
(12) Patent Application Publication
(10) Pub. No.: US 2005/0012614 A1
(43) Pub. Date: Jan. 20, 2005

(54) Method for securing air traffic

(76) Inventor: Joergen Brosow, Plainfeld (AT)

Correspondence Address: Friedrich Kueffner, 317 Madison Avenue, Suite 910, New York, NY, 10017, US

(21) Appl. No.: 10/495,718

(22) PCT Filed: Nov. 14, 2002
(86) PCT No.: PCT/EP02/12771

(30) Foreign Application Priority Data
Nov. 15, 2001 (DE) 101 56 038.9

(51) Int. Cl. G08B 13/14

(52) U.S. Cl. 340/572.1

(57) ABSTRACT

To enhance the security of air traffic, tamperproof recordings are produced on the passenger's boarding pass, which have a unique relationship with the identity of the passenger and his luggage. This relationship is monitored from the time the passenger checks in at the departure airport until he leaves the destination airport.

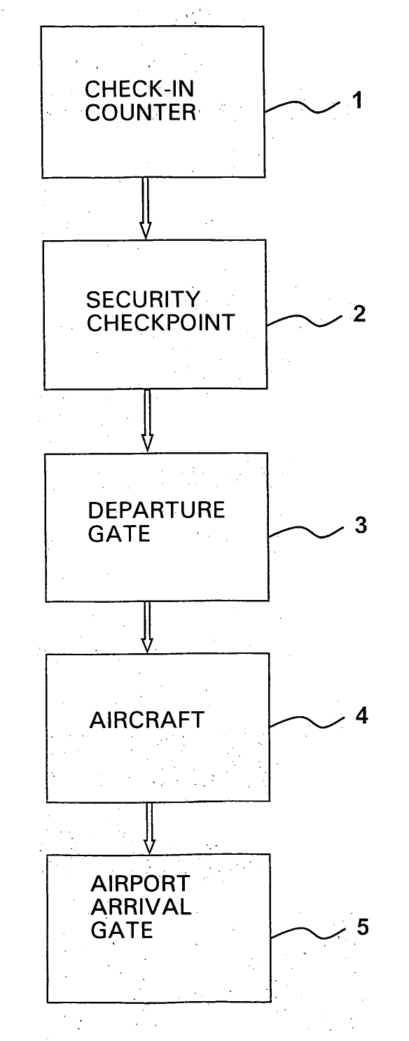

The invention concerns a method for providing air traffic security, in which each passenger at the airport goes to a check-in counter, at which, on presentation of an airline ticket previously issued to him for a reserved flight, he is issued a boarding pass, which entitles him to board the aircraft for the reserved flight and has two portions, one of which is retained by the passenger to allow him to board, and on each of which information identifying the reserved flight, the passenger, and his seat assignment on the aircraft is recorded and is stored in a central data bank, and at which (check-in counter) luggage is checked, and each checked piece of luggage is assigned luggage identification information, which accompanies both the checked pieces of luggage and the passenger, the passenger then passes through a security checkpoint, at which he and any carry-on luggage are checked, and then the passenger proceeds to the departure gate assigned to the reserved flight, at which he presents his boarding pass, receives the portion of the boarding pass that he is to retain, and boards the aircraft.

Especially recently, airline hijackings have again shown that the security method customarily used in airports has considerable security deficiencies despite the various screenings associated with it. The screening of passengers and possibly their luggage that occurs in the customary method has thus proven to be inadequate.

The objective of the invention is to develop a method of the type described above, which leads to significant enhancement of air traffic security.

In accordance with the invention, this objective is achieved by virtue of the fact that luggage identification information is also assigned to carry-on luggage at the check-in counter and accompanies it, and the luggage identification information assigned to the checked luggage and the carry-on luggage is recorded on both portions of the boarding pass.

This creates a permanent association between the boarding pass and carry-on luggage, which can be checked at any time, even after the passenger has been checked in at the check-in counter, by comparing the luggage identification information recorded on the boarding pass and the luggage identification information accompanying the carry-on luggage. At the same time, the recording on the boarding pass of the luggage identification information assigned to the checked luggage also creates an association between the checked luggage and the boarding pass, and this association is also permanent and can be checked at any time.

It is advantageous if the method is additionally designed in such a way that the boarding pass is issued at the check-in counter only upon the presentation by the passenger of an official personal identification document, and information characterizing the personal identification document is recorded on both portions of the boarding pass. This creates an association between the passenger and the boarding pass that can be checked at any time. A possible exchange of boarding passes between passengers or an exchange of their luggage, especially carry-on luggage, can be discovered at any time in this way.

With additional refinement of the security screening customarily carried out after the check-in at the check-in counter, the method of the invention is advantageously carried out in such a way that the luggage identification information assigned to the carry-on luggage and stored in the boarding pass and the luggage identification information accompanying the carry-on luggage are automatically read and checked for agreement at the security checkpoint. Therefore, this screening makes it possible to detect whether the carry-on luggage has been exchanged. In this case, nonagreement can automatically trigger an alert, and a special screening can then be initiated.

In addition, the method of the invention is designed in such a way that a scanner image of the carry-on luggage is prepared at the security checkpoint and stored in the central data bank. This makes it possible to detect any change in the contents of the carry-on luggage that may have occurred after the security screening by rescanning the carry-on luggage and comparing the new scanner image with the scanner image stored on the boarding pass.

This check of the carry-on luggage for changes in its contents in accordance with the method of the invention is advantageously carried out by preparing a new scanner image of the carry-on luggage at the departure gate and automatically comparing it with the stored scanner image that was prepared at the security checkpoint. Many well-known algorithms are available for accomplishing this comparison of the scanner images. Some of these algorithms have extensive recognition capabilities that make it possible to determine whether only local changes in the position of some of the contents have occurred between the two scanner images or whether some contents have been added or removed. Only in the latter case is it necessary to produce an alert, which then leads to re-inspection of the carry-on luggage at the departure gate.

In an effective further refinement of the method, all or at least some of the information recorded on the boarding pass, especially the information identifying the reserved flight, the passenger and his seat assignment on the aircraft, as well as the luggage identification information assigned to the checked luggage and the carry-on luggage and even the scanner images of the carry-on luggage are stored in the central data bank.

In this connection, in an especially effective variant of the method, when the passenger arrives at the departure gate, the luggage identification information assigned to the checked luggage and stored in the boarding pass is automatically read and compared with the luggage identification information stored in the central data bank. In this way, when the passenger passes through the departure gate to board the aircraft, it is possible to check whether the luggage that he checked-in has actually already been loaded in the aircraft's cargo compartment or is ready to be loaded.

Before the passenger boards the plane, his portion of the boarding pass is separated from the boarding pass and returned to him, and the remaining portion of the boarding pass is retained at the departure gate. In an advantageous further development of the method of the invention, after the passenger has boarded the aircraft, he inserts the retained portion of the boarding pass into a terminal provided at his seat location. The terminal then reads the information recorded on this portion of the boarding pass and transmits it to an on-board computer of the aircraft, in which it is compared with the information previously transmitted to the on-board computer from the central data bank. This verifies the arrival on the aircraft of the passenger identified by the boarding pass. The crew and possibly security personnel, such as the air marshals that have been under consideration lately, can monitor precisely the boarding operation and the occupation of the seats by means of the on-board computer.

In addition, it is advantageous to design this procedure in such a way that a signal is transmitted to the on-board computer by a sensor provided in the seat location to indicate the presence or absence of the passenger in the seat. This allows the on-board computer to monitor whether the passenger in question has actually taken his seat. If a passenger leaves his seat, this is also immediately indicated.

It is further provided that the passenger, on boarding the aircraft, places his carry-on luggage in the overhead compartment above his seat, which has a reading device, which reads the luggage identification information that accompanies the luggage and transmits it to an on-board computer of the aircraft, in which it is compared with the information previously transmitted to the on-board computer from the central data bank. This enables the on-board computer to determine where the carry-on luggage belonging to the passenger is located and especially whether is has been placed directly above his seat, as is now required.

In accordance with a further refinement of the method of the invention, in addition to the monitoring of the on-board computer by personnel, provision may be made for the on-board computer to automatically produce alerts on the basis of the evaluation of the information transmitted to it. For example, these alerts could be triggered if the on-board computer detects unusual changes and movements at the passenger seats and/or in the carry-on luggage compartments. The alerts may also be recorded in the flight data recorder. It is also possible to automatically transmit them to ground stations, where suitable measures can be immediately initiated.

In accordance with the invention, it is further provided that when the passenger leaves the aircraft, he takes his portion of the boarding pass with him as far as a security checkpoint beyond the baggage claim area, at which the luggage identification information stored on his portion of the boarding pass and the luggage identification information that accompanies the luggage are automatically read and checked for agreement. This check ensures that the passenger collects all of his luggage again, i.e., both his checked luggage and his carry-on luggage, and takes it to the airport exit.

The reliability of this screening is further enhanced by destroying the passenger's portion of the boarding pass and the information carrier that carries the luggage identification information and accompanies the luggage. This destruction can be accomplished, for example, by designing the information carrier as a sticker, which can be destroyed by tearing it off. However, the destruction can also be accomplished by an optical or electromagnetic effect that destroys the recorded information content.

To improve the ability to track and monitor the performance of the method of the invention, it is also useful for information identifying the check-in counter and/or the security checkpoint to be recorded on the boarding pass at the check-in counter or security checkpoint. Achievement of this goal is also assisted by recording the time of check-in and/or the time of the security check on the boarding pass at the check-in counter and/or the security checkpoint. In this way, exact information is recorded on the boarding pass and possibly in the central data bank with respect to when and at which specific station of the airport the check-in and security screening were carried out.

Another possibility for enhancing security consists in recording a secret alert on the boarding pass at the check-in counter, which is then automatically displayed at the security checkpoint. This enables the personnel at the check-in counter to make a secret recording with respect to possible peculiarities of the passenger, even if they are unable to objectify them, and in this way to provide the personnel at the security checkpoint with an advance warning that this passenger should be more carefully scrutinized at the security screening.

To ensure that the method proceeds smoothly and to achieve a high degree of anticounterfeiting security in carrying out the method of the invention, it is advantageous for a sheet-like carrier with two portions to be used as the boarding pass. Each portion is provided with an electronic memory circuit. In particular, a suitable carrier may consist of paper or thin cardboard, on which the electronic memory circuits are mounted or in whose material the electronic memory circuits are embedded. In this regard, it is preferred for each of the two memory circuits to have an integrated-circuit chip joined with the sheet-like carrier. Information carriers of this type and associated reading/writing methods have already been basically described in the earlier published patent applications DE 198 33 746, DE 198 49 762, DE 199 08 172, and PCT/EP99/05,390, from which the expert can recognize their applicability to the present method.

A preferred refinement of the present method provides that each of the two integrated-circuit chips has an individual serial number, and that the serial number of each integrated-circuit chip is stored in the other integrated-circuit chip. As is well known, integrated-circuit chips are given their own individual serial numbers during their manufacture. The mutual storage of these individual serial numbers in the two integrated-circuit chips also electronically secures the connection between the two portions of the boarding pass, so that it is not possible to tamper with a boarding pass by taking portions of different boarding passes and reattaching them to noncorresponding portions of other boarding passes. The correct matching of the two portions of the boarding passes documented by the stored serial numbers can be checked at the check-in counter and rechecked at any later security screening.

In another advantageous alternative refinement, the boarding pass consists of a sheet-like carrier, each of whose two portions is provided with an optically readable and writable memory. As in the case of electronic storage and reading methods, the optical storage and reading can be carried out automatically, quickly, and without contact.

In regard to the necessary handling of the luggage identification information in accordance with the method of the invention, it is advantageous for the luggage identification information that accompanies the carry-on luggage and the checked luggage to be recorded on a carrier, which can be applied or attached to the given piece of luggage and whose detachment from the piece of luggage causes the destruction of the recorded information.

As in the case of the boarding pass, it may be provided that the carrier is a sheet-like material that is provided with a readable and writable electronic memory circuit, or, alternatively, that the carrier is a sheet-like material that is provided with an optically readable and writable memory.

To enhance anticounterfeiting security with respect to both the boarding pass and the carrier that contains the luggage identification information, it is advantageous for the memory cells of the memory to be writable only a single time. This makes it impossible for the information recorded at the check-in counter or at subsequent security checkpoints to be written over with other recorded information at a later time.

An embodiment of the method of the invention is described and explained below with reference to the drawing, which shows the steps of this particular procedure in the form of a flowchart.

Sometime before he is to travel by air, the passenger purchases an airline ticket for the desired flight from an authorized ticket agent, who issues the ticket in the passenger's name. On the day of his scheduled flight, the passenger takes his ticket to the airline check-in counter, which is symbolized in the flowchart by block 1. At the check-in counter 1, the passenger presents his airline ticket and an official personal identification document, for example, his passport. In addition, he presents any carry-on luggage and gives any luggage that is to be checked to the check-in counter personnel.

The check-in counter personnel issue him a boarding pass in exchange. In the present embodiment, the boarding pass is designed in the conventional form of a paper card that consists of two portions. In addition, each of the two portions is provided with an electronic memory circuit, which may be embedded in the paper or applied to the surface of the paper. Each of the memory circuits has an integrated-circuit chip and an antenna structure connected to it, which may be designed as a loop antenna or as a dipole antenna. This makes it possible to write to them and read them in much the same way as conventional chip cards with a read/write device provided at the check-in counter.

At the check-in counter, the individual serial number, assigned by the manufacturer, of the integrated-circuit chip provided on one of the portions of the boarding pass is stored in the integrated-circuit chip of the other portion of the boarding pass and vice versa. Furthermore, information that identifies the check-in counter and the date and time of the check-in procedure is stored in both integrated-circuit chips. In addition, information characterizing the personal identification document presented by the passenger, for example, his passport number, is stored in the integrated-circuit chips of both portions of the boarding pass.

Luggage identification information is stored in both integrated-circuit chips of the boarding pass for each piece of carry-on luggage and checked luggage. In addition, information carriers are produced, in which the luggage identification information is recorded and which accompany each piece of luggage. These information carriers which accompany the luggage may have the form of conventional tags or stickers, which are attached or applied to the corresponding piece of luggage in such a way that they cannot be removed from the piece of luggage without destroying the recorded information. Like the boarding passes, the information carriers which accompany the luggage can be made of paper that has been provided with memory circuits that can be read and written to without contact.

If the passenger seems conspicuous or suspicious to the personnel working at the check-in counter for any reason, despite the fact that his personal identification and luggage are in order, they can store an alert in the boarding pass and/or the information carriers that accompany the luggage, and the recording of this alert cannot be noticed by the passenger who has checked in.

All of the information stored in the boarding pass and the information carriers that accompany the luggage is also recorded in a central data bank of the airport.

After this check-in procedure, the passenger proceeds in the usual way to a security checkpoint, which is symbolized in the flowchart by block 2. At the security checkpoint 2, the passenger passes through a conventional walk-through metal detector for detecting any metallic objects he may be carrying. His carry-on luggage is passed through an x-ray scanner in the usual way. In addition, the luggage identification information recorded on the information carrier that accompanies the carry-on luggage is automatically read and compared with the luggage identification information recorded on the boarding pass. If the information does not agree, the personnel at the security checkpoint are alerted.

If an alert has been recorded, this is also read out, and the security personnel thus receive an advance warning to be more vigilant than usual. The personnel at the security checkpoint have the same opportunity as the check-in counter personnel to record an alert on the boarding pass and the information carrier that accompanies the carry-on luggage in the event that they have any suspicions about a passenger. As at the check-in counter 1, all read/write procedures are carried out automatically and without contact at the security checkpoint 2.

A check is also performed at the security checkpoint to determine whether the correct corresponding serial numbers are stored in the integrated-circuit chips of the two portions of the boarding pass. This makes it possible to detect boarding pass tampering, in which separated portions of different boarding passes have been put together to simulate an intact, untampered boarding pass.

As at the check-in counter 1, information that identifies the security checkpoint and the time and date of the security screening are recorded in the two integrated-circuit chips of the boarding pass at the security checkpoint 2.

Finally, the scanner image of the luggage produced at the security checkpoint is stored in the central data bank along with the other information already stored there.

After the passenger has passed through the security checkpoint 2, he proceeds to the departure gate, which is symbolized in the flowchart by block 3. At the departure gate 3, the carry-on luggage is passed through another x-ray scanner, and the scanner image is likewise stored in the central data bank. In addition, this new scanner image is automatically compared with the scanner image produced earlier at the security checkpoint 2. If this comparison reveals a difference due to a change in the luggage contents, an alert signal is produced, and another manual inspection is performed.

As at the security checkpoint 2, the luggage identification information recorded on the information carrier that accompanies the carry-on luggage is compared at the departure gate 3 with the corresponding luggage identification information recorded on the boarding pass. In addition, the luggage identification information for the checked luggage is read from the boarding pass and compared with the luggage identification information recorded on the information carriers that accompany the pieces of checked luggage, which have been loaded onto the aircraft or are ready to be loaded. This tracking procedure ensures that precisely those pieces of luggage that were checked by the passengers at the check-in counter i are loaded on the aircraft, or, to put it another way, for each piece of loaded luggage that was checked in, the corresponding passenger boards the plane.

After all of these checks have been performed, the portion of the boarding pass to be retained by the passenger is separated from the other portion of the boarding pass and given back to the passenger as he is about to board the plane.

The passenger then proceeds to his assigned seat on the aircraft, which is symbolized in the flowchart by block 4. The passenger's seat assignment is identified on his boarding pass. A reading device is built into the seat, for example, in the armrest, and the passenger inserts the portion of the boarding pass that he has retained into the reading device, which reads the information that identifies the passenger from the passenger's portion of the boarding pass and transmits it to the aircraft's on-board computer.

Before the passenger takes his seat, he places his carry-on luggage in the overhead luggage compartment above his seat. A reading device installed there reads the luggage identification information from the information carrier that accompanies the carry-on luggage and likewise transmits it to the on-board computer.

The on-board computer, which has been up-dated with the passenger and luggage identification information from the central data bank, checks whether the information received from the central data bank agrees with the information transmitted by the reading devices in the armrests and overhead luggage compartments. In addition, each seat is equipped with a sensor,
which transmits a signal to the on-board computer to indicate whether the passenger has actually sat down in his seat. An alert previously recorded in the boarding pass due to a suspicious factor is also transmitted to the on-board computer. In this way, the flight crew can monitor all movements of passengers and luggage during the entire flight with the assistance of the on-board computer. Suitable monitoring software of the on-board computer automatically generates an alert signal to the flight crew in the event of any movements of an unusual nature and/or extent.

After the aircraft has arrived at its destination airport, each passenger proceeds with his carry-on luggage and his portion of the boarding pass to the airport arrival area, which is symbolized in the flowchart by block 5. If he has any checked luggage, he picks it up in the baggage claim area. He then passes through a security checkpoint, at which the luggage identification information stored in his portion of the boarding pass and the luggage identification information accompanying the individual pieces of carry-on luggage and checked luggage are automatically read and checked for agreement. If there is a lack of agreement, the security checkpoint personnel take steps o correct the problem. If the information does agree, the passenger's portion of the boarding pass and the luggage identification information accompanying the luggage are voided by destruction. This may be accomplished both by mechanical destruction and by automatic electronic or optical destruction.

1. Method for providing air traffic security, in which each passenger at the airport goes to a check-in counter (1), at which, on presentation of an airline ticket previously issued to him for a reserved flight, he is issued a boarding pass, which entitles him to board the aircraft for the reserved flight and has two portions, one of which is retained by the passenger to allow him to board, and on each of which information identifying the reserved flight, the passenger, and his seat assignment on the aircraft is recorded and is stored in a central data bank, and at which (check-in counter) luggage is checked, and each checked piece of luggage is assigned luggage identification information, which accompanies both the checked pieces of luggage and the passenger, the passenger then passes through a security checkpoint (2), at which he and any carry-on luggage are checked, and then the passenger proceeds to the departure gate (3) assigned to the reserved flight, at which he presents his boarding pass, receives the portion of the boarding pass that he is to retain, and boards the aircraft, wherein luggage identification information is also assigned to the carry-on luggage and accompanies it, and the luggage identification information assigned to the checked luggage and the carry-on luggage is recorded on both portions of the boarding pass.

2. Method in accordance with claim 1, wherein the luggage identification information assigned to the carry-on luggage and recorded in the boarding pass and the luggage identification information that accompanies the carry-on luggage are automatically read at the security checkpoint (2) and checked for agreement.

3. Method in accordance with claim 2, wherein information identifying the check-in counter (1) and/or the security checkpoint (2) is recorded on the boarding pass at the check-in counter or security checkpoint.

4. Method in accordance with claim 2, wherein information that identifies the time at which the check-in procedure and/or security screening was carried out is stored on the boarding pass at the check-in counter: (1) and/or the security checkpoint (2).

5. Method in accordance with claim 2, wherein a scanner image of the carry-on luggage is produced at the security checkpoint (2) and stored on the boarding pass.

6. Method in accordance with claim 2, wherein a scanner image of the carry-on luggage is produced at the security checkpoint (2) and stored in a central data bank.

7. Method in accordance with claim 2, wherein a secret alert is recorded on the boarding pass at the check-in counter (1), which is then automatically displayed at the security checkpoint (2).

8. Method in accordance with claim 1, wherein another scanner image of the carry-on luggage is produced at the departure gate (3) and automatically compared with the stored scanner image previously produced at the security checkpoint (2).

9. Method in accordance with claim 8, wherein the scanner image produced at the departure gate (3) is stored in the central data bank.

10. Method in accordance with claim 1, wherein the luggage identification information assigned to the checked luggage and stored in the boarding pass is automatically read at the departure gate (3) and compared with the luggage identification information stored in the central data bank.

11. Method in accordance with claim 1, wherein when the passenger boards the aircraft (4), he inserts the portion of the boarding pass that he has retained into a terminal provided at his seat, which reads the information recorded on his portion of the boarding pass and transmits it to an on-board computer of the aircraft, in which it is compared with the information previously transmitted to the on-board computer from the central data bank.

12. Method in accordance with claim 11, wherein a sensor provided in the seat transmits a signal to the on-board computer to indicate the presence of the passenger in the seat or his absence from the seat.

13. Method in accordance with claim 1, wherein when the passenger boards the aircraft (4), he places his carry-on luggage in the overhead luggage compartment above his seat, which has a reading device, which reads the luggage identification information that accompanies the carry-on luggage and transmits it to the aircraft's on-board computer, in which it is compared with the information previously transmitted to the on-board computer from the central data bank.

14. Method in accordance with claim 11, wherein the on-board computer automatically generates an alert on the basis of its evaluation of the information transmitted to it.

15. Method in accordance with claim 14, wherein the alerts are recorded in the-flight data recorder.

16. Method in accordance with claim 14, wherein the alerts are transmitted to a ground station.

17. Method in accordance with claim 1, wherein when the passenger leaves the aircraft (4), he takes his portion of the boarding pass with him as far as a security checkpoint (5) located beyond the baggage claim area, at which the luggage identification information stored on his portion of the boarding pass and the luggage identification information that accompanies the luggage are automatically read and checked for agreement.

18. Method in accordance with claim 17, wherein the passenger's portion of the boarding pass and the information carriers that carry the luggage identification information and accompany the luggage are destroyed after the passenger has passed through the security checkpoint (5).

19. Method in accordance with claim 1, wherein the boarding pass is issued at the check-in counter only after the passenger has presented an official personal identification document, and information identifying the personal identification document has been recorded on both portions of the boarding pass.

20. Method in accordance with claim 19, wherein the recorded information is stored in the central data bank.

21. Method in accordance with claim 1, wherein a sheet-like carrier is used as the boarding pass, each of whose two portions is provided with an electronic memory circuit.

22. Method in accordance with claim 21, wherein each of the two memory circuits has an integrated-circuit chip joined with the sheet-like carrier.

23. Method in accordance with claim 22, wherein each of the two integrated-circuit chips has an individual serial number, and the serial number of each integrated-circuit chip is stored in the other integrated-circuit chip.

24. Method in accordance with claim 1, wherein a sheet-like carrier is used as the boarding pass, each of whose two portions is provided with an optically readable and writable memory.

25. Method in accordance with claim 1, wherein the memory cells of the memory are writable only a single time.

26. Method in accordance with claim 1, wherein the luggage identification information that accompanies the carry-on luggage and the checked luggage is recorded on a carrier, which can be applied or attached to the given piece of luggage and whose detachment from the piece of luggage causes the destruction of the recorded information.

27. Method in accordance with claim 26, wherein the carrier is a sheet-like material that is provided with a readable and writable electronic memory circuit.

28. Method in accordance with claim 27, wherein the carrier is a sheet-like material that is provided with an optically readable and writable memory.

29. Method in accordance with claim 27, wherein the memory cells of the memory are writable only a single time.

30. Method in accordance with claim 21, wherein the read/write operations of the memories are carried out without contact.
